(19) United States
(12) Patent Application Publication
(10) Pub. No.: US 2008/0091323 A1
(43) Pub. Date: Apr. 17, 2008

(54) Vehicle Integrated-Control Apparatus and Method

(75) Inventors: Seiji Kuwahara, Aichi-ken (JP); Masato Kaigawa, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/793,329

(22) PCT Filed: Mar. 27, 2006
(86) PCT No.: PCT/IB06/00697

§ 371 Date: Jun. 19, 2007

(30) Foreign Application Priority Data
Mar. 31, 2005 (JP) 2005-102672

(51) Int. Cl. G06F 17/00

(52) U.S. Cl. 701/54

(57) ABSTRACT

In a vehicle integrated-control apparatus and method applied to a vehicle provided with a power train including a drive source and a transmission, a control target value is primarily derived based on an instruction provided by a driver or an automatic operating device; two control target values that are expressed in a same unit of physical quantity as that of the control target value and that differ from each other are intermediately derived based on the control target value; control targets (target engine torque, target shift speed) that are expressed by units of physical quantities or modes appropriate for control of the drive source and control of the transmission are derived based on the intermediately derived control target values, respectively; and the drive source and the transmission are controlled to achieve the finally derived control targets.

### BACKGROUND OF THE INVENTION

1. Field of the Invention

The invention relates to a vehicle integrated-control apparatus that is mounted in a vehicle provided with a power train including a drive source and a transmission and that controls the drive source and the transmission in an integrated manner, and a vehicle integrated-control method for controlling the power source and the transmission in an integrated manner.

2. Description of the Related Art

For example, Japanese Patent Application Publication No. JP-A-2002-180860 describes a technology for calculating the target engine torque and the target shift speed according to the target axle torque calculated based on the accelerator pedal operation amount, the vehicle speed, etc.

To control an engine and a transmission in appropriate coordination and in an integrated manner, the final control target values for the engine and the transmission (e.g. the target engine torque and the target shift speed) need to be determined based on the same target value determined based, for example, on the accelerator pedal operation amount.

However, the engine torque differs from the shift speed in response, etc. Accordingly, with the configuration described above where both the target engine torque and the target shift speed are calculated based on the same target axle torque, it is difficult to individually control the engine and the transmission at appropriate times. For example, if the control target value is smoothed to prevent a rapid change in the driving force, shifting is likely to be delayed.

### SUMMARY OF THE INVENTION

It is an object of the invention to provide a vehicle integrated-control apparatus and method that can individually control a drive source and a transmission at appropriate times while taking the difference in properties, such as response, between the engine toque and the shift speed into account.

A first aspect of the invention relates to a vehicle integrated-control apparatus that is mounted in a vehicle provided with a power train including a drive source and a transmission, and that controls the drive source and the transmission in an integrated manner. The vehicle integrated-control apparatus includes first target value deriving means for primarily deriving a control target value based on an instruction provided by a driver or an automatic operating device; second target value deriving means for intermediately deriving, based on the control target value, two control target values that are expressed in the same unit of physical quantity as that of the control target value, and that differ from each other; third target value deriving means for finally deriving control targets that are expressed by units of physical quantities or modes appropriate for control of the drive source and control of the transmission based on the intermediately derived control target values, respectively; and a controller that controls the drive source and the transmission to achieve the finally derived control targets.

A second aspect of the invention relates to a vehicle integrated-control method that is applied to a vehicle provided with a power train including a drive source and a transmission, and that is performed to control the drive source and the transmission in an integrated manner. The vehicle integrated-control method includes primarily deriving a control target value based on an instruction provided by a driver or an automatic operating device; intermediately deriving, based on the control target value, two control target values that are expressed in the same unit of physical quantity as that of the control target value, and that differ from each other; finally deriving control targets that are expressed by units of physical quantities or modes appropriate for control of the drive source and control of the transmission based on the intermediately derived control target values, respectively; and controlling the drive source and the transmission to achieve the finally derived control targets.

The vehicle integrated-control apparatus may include a first signal transmission system that transmits a signal indicating the control target primarily derived based on the instruction provided by the driver or the automatic operating device to a drive source control unit that controls the drive source; and a second signal transmission system that transmits the signal to a transmission control unit that controls the transmission. Also, the vehicle integrated-control apparatus may intermediately derive the control target values by correcting the signal transmitted through the first signal transmission system such that the signal transmitted through the first signal transmission system has a waveform different from a waveform of the signal transmitted through the second signal transmission system.

With the vehicle integrated-control apparatus and method described above, it is possible to individually control the drive source and the transmission at appropriate times while taking the difference in properties, such as response, between the engine toque and the shift speed into account.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 illustrates the top view of a vehicle provided with a vehicle integrated-control apparatus according to the invention, in which a driving force control device is embedded;

FIG. 2 illustrates the system diagram of the vehicle integrated-control apparatus according to an embodiment of the invention;

FIG. 3 illustrates the graph showing an example of the three-dimensional map that defines the relationship among the accelerator pedal operation amount (%), the wheel speed No (rpm), and the target acceleration G (m/s²);

FIG. 4A illustrates an example of the manner in which the target driving force F1 changes; and

FIG. 4B illustrates an example of the target driving force F1_{EGN} (indicated by the solid line) used for engine control, which is derived by correcting the target driving force F1 (indicated by the dashed line).

### DETAILED DESCRIPTION OF THE EXAMPLE EMBODIMENT

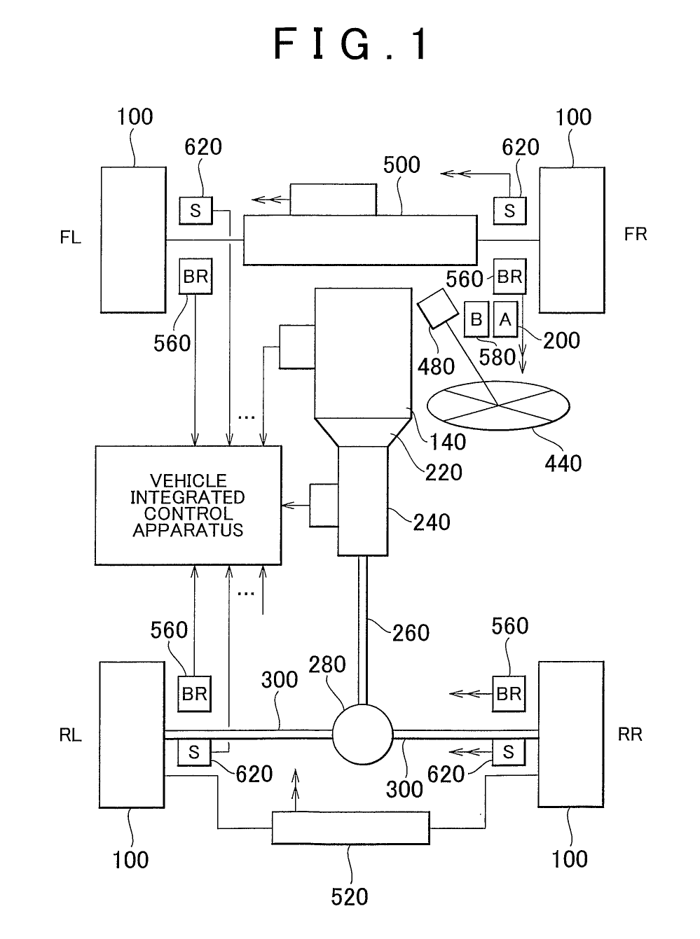

In the following description and the accompanying drawings, the present invention will be described in more detail in terms of an example embodiment. First, a vehicle including a vehicle integrated-control apparatus according to the invention will be described with reference to FIG. 1.

The vehicle is provided with right and left front wheels 100 and right and left rear wheels 100. In FIG. 1, “FR” denotes the right front wheel, “FL” denotes the left front wheel, “RR” denotes the right rear wheel, and “RL” denotes the left rear wheel.

The vehicle includes an engine 140 as a power source. The power source is not limited to an engine. An electric motor may be used as the sole power source. Alternatively, an engine and an electric motor may be used in combination as the power source. The power source for the electric motor may be a secondary battery or a fuel cell.

The operating state of the engine 140 is electrically controlled based on the operation amount of an accelerator pedal 200 (one of the input members operated by the driver to control the forward movement, backward movement, speed, or acceleration of the vehicle) by the driver. If necessary, the operating state of the engine 140 may be automatically controlled independently of the operation of the accelerator pedal 200 by the driver.

The engine 140 is electrically controlled by electrically controlling, for example, the opening amount of a throttle valve (not shown) (hereinafter, referred to as a “throttle valve opening amount”) provided in an intake manifold of the engine 140, the amount of fuel injected into a combustion chamber of the engine 140, or the angular position of an intake camshaft that adjusts the valve opening/closing timing.

The example vehicle is a rear-wheel drive vehicle where the right and left front wheels are the driven wheels and the right and left rear wheels are the drive wheels. Accordingly, the output shaft of the engine 140 is connected to the right and left rear wheels via a torque converter 220, a transmission 240, a propeller shaft 260, a differential gear unit 280, and a drive shaft 300 that rotates along with the rear wheels. The torque converter 220, the transmission 240, the propeller shaft 260, and the differential gear unit 280 are power transmission elements shared by the right and left rear wheels. However, the application of vehicle integrated-control apparatus according to the embodiment is not limited to rear-wheel drive vehicles. The vehicle integrated-control apparatus may be applied, for example, to front-wheel drive vehicles where the right and left front wheels are the drive wheels and the right and left rear wheels are the driven wheels. Also, the vehicle integrated-control apparatus may be applied to four-wheel drive vehicles where all the wheels are the drive wheels.

The transmission 240 is an automatic transmission. The automatic transmission electrically controls the speed ratio, based on which the speed of the engine 140 is converted into the rotational speed of the output shaft of the transmission 240. This automatic transmission may be either a stepped transmission or a continuously variable transmission (CVT).

The vehicle includes a steering wheel 440 operated by the driver. A steering reaction force supply device 480 electrically supplies the steering wheel 440 with a steering reaction force, that is, a reaction force corresponding to the operation of the steering wheel 440 performed by the driver (hereinafter, sometimes referred to as “steering”). The steering reaction force can be electrically controlled.

The orientation of the right and left front wheels, namely, the steering angle of the front wheels is electrically controlled by a front steering device 500. The front steering device 500 controls the steering angle of the front wheels based on the angle by which the driver has turned the steering wheel 440. If necessary, the front steering device 500 may automatically control the steering angle of the front wheels independently of the operation of the steering wheel 440 by the driver. In other words, the steering wheel 440 may be mechanically isolated from the right and left front wheels.

Similarly, the orientation of the right and left rear wheels, namely, the steering angle of the rear wheels is electrically controlled by a rear steering device 520.

The wheels 100 are provided with respective brakes 560 that are applied to suppress rotation of the wheels 100. The brakes 560 are electrically controlled based on the operation amount of a brake pedal 580 (one of the input members operated by the driver to control the forward movement, backward movement, speed, or deceleration of the vehicle) by the driver. If necessary, the wheels 100 may be individually and automatically controlled.

In the example vehicle, the wheels 100 are connected to the vehicle body (not shown) via respective suspensions 620. The suspension properties of each suspension 620 can be electrically controlled independently of the other suspensions 620.

The following actuators are used to electrically control the corresponding components described above:
(1) an actuator that electrically controls the engine 140;
(2) an actuator that electrically controls the transmission 240;
(3) an actuator that electrically controls the steering reaction force supply device 480;
(4) an actuator that electrically controls the front steering device 500;
(5) an actuator that electrically controls the rear steering device 520;
(6) actuators that electrically control the brakes 560; and
(7) actuators that electrically control the suspensions 620.

Only commonly used actuators are listed above. Whether all the actuators listed above are required depends on the specifications of the vehicles. Some vehicles do not include one or more actuators listed above. Alternatively, other vehicles may include other actuators, in addition to the actuators listed above, such as an actuator used to electrically control the ratio between the steering amount of the steering wheel 440 and the steered amount of the steered wheel (steering ratio), and an actuator used to electrically control a reaction force of the accelerator pedal 200. Accordingly, the invention is not limited to the particular actuator configurations mentioned above.

As shown in FIG. 1, the vehicle integrated-control apparatus that is mounted in the vehicle is electrically connected to the various actuators described above. A battery (not shown) serves as the electric power source for the vehicle integrated-control apparatus.

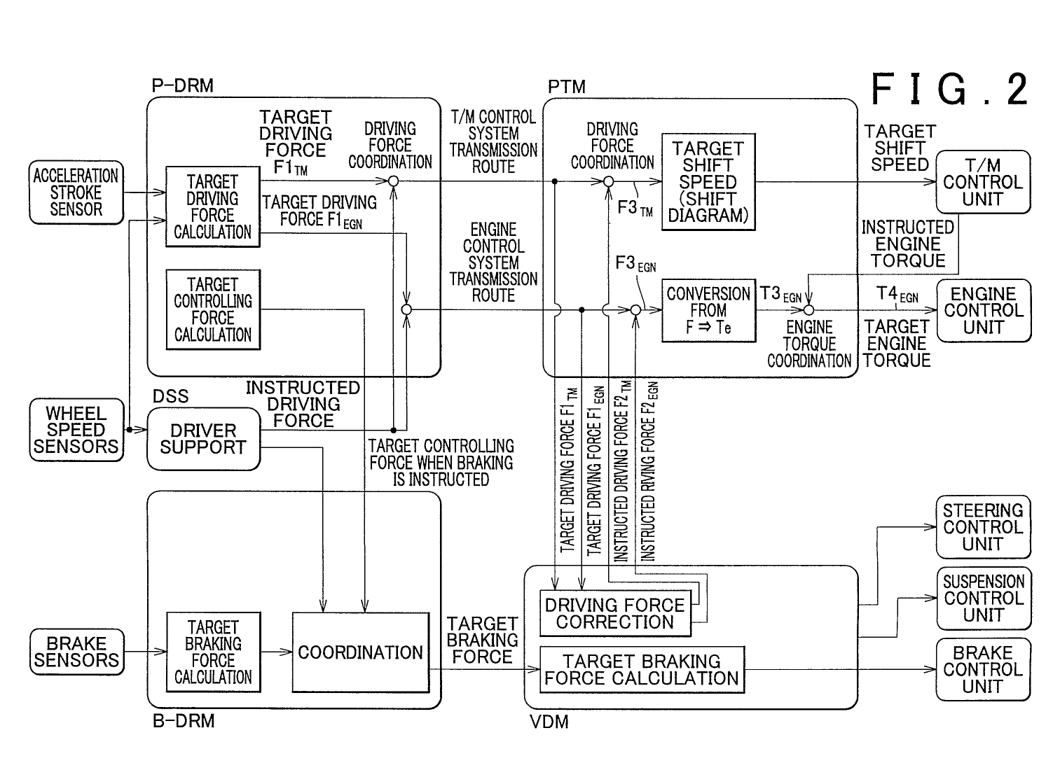

FIG. 2 illustrates the system diagram of the vehicle integrated-control apparatus according to the embodiment of the invention.

As in the case of a commonly used ECU (electronic control unit), each manager (and model) described below may be a microcomputer that includes, for example, ROM that stores control programs, RAM where results of calculations and the like are stored and the data can be retrieved and/or updated, a timer, a counter, an input interface, an output interface, and the like. In the following description, the control units are grouped by function, and referred, for example, to as a P-DRM, a VDM, and the like. However, the P-DRM, the VDM, and the like need not be configurations physically independent of each other. The P-DRM, the VDM, and the like may be configured integrally with each other using an appropriate software structure.

As shown in FIG. 2, at the highest level of the drive control system, a manager that functions as a driver's intention determining portion of the drive control system (hereinafter, referred to as a “P-DRM”: Power-Train Driver Model) is arranged. At the highest level of the drive control system, a driver support system (hereinafter, referred to as a “DSS”: Driver Support System) is arranged in parallel to the P-DRM.

At the level superior to the P-DRM, an acceleration stroke sensor is arranged. The acceleration stroke sensor produces an electric signal corresponding to the operation amount of the accelerator pedal 200, which directly reflects the input of the driver.

At the level superior to the DSS, wheel speed sensors are arranged. The wheel speed sensors are provided for the respective wheels 100. Each wheel speed sensor 100 outputs a pulse signal each time the wheel 100 rotates through a predetermined angle.

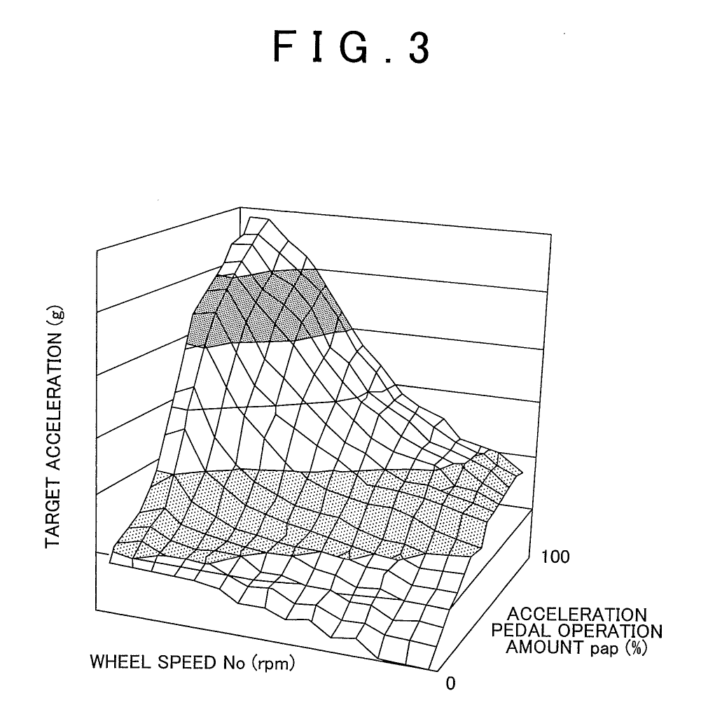

The P-DRM receives the signals output from the acceleration stroke sensor and the wheel speed sensors. At the highest level in the P-DRM, a target driving force calculation portion calculates a target driving force F1 based on the accelerator pedal operation amount (%) and the wheel speed No (rpm) indicated by the electric signals from the acceleration stroke sensor and the wheel speed sensors, respectively. The target driving force F1 may be derived in the following manner: 1) the target acceleration G (m/s²) is calculated based, for example, on an appropriate three-dimensional map in FIG. 3, using the accelerator pedal operation amount (%) and the wheel speed (rpm) as parameters, 2) the target driving force is derived by converting the target acceleration G (m/s²) into the physical quantity suitable for force (N), and 3) the target driving force F1 is derived by correcting the target driving force using an uphill-slope compensation amount (N) that is determined based on running resistance (N) and a road inclination.

The target driving force calculation portion according to the embodiment derives a target driving force F1_{EGN} (N) and a target driving force F1_{TM} (N) based on the target driving force F1 (N) derived as described above. As shown in FIG. 2, the signals indicating the target driving force F1_{EGN} and the target driving force F1_{TM} are transmitted to an engine control unit and a T/M (transmission) control unit via two signal lines extending from the target driving force calculation portion, respectively. Hereafter, the routes through which the signals that indicate the target driving force F1_{EGN} and the target driving force F1_{TM} are transmitted will be referred to as an “engine control system transmission route” and a “T/M control system transmission route”, respectively.

In the embodiment, the signals indicating the target driving force F1_{EGN} and the target driving force F1_{TM}, derived from the same target driving force F1 and coordinated with each other, are output to the engine control unit and the T/M control unit via the transmission routes, and used for engine control and shift control, respectively. Thus, the engine control and the shift control can be performed in an integrated manner and in appropriate coordination.

According to the embodiment, the target driving force F1_{EGN} and the target driving force F1_{TM} that are used for the engine control and the shift control, respectively, are derived from the same target driving force F1. It is, therefore, possible to make individual correction to the target driving force to perform appropriate engine control and the shift control, while maintaining appropriate coordination between the engine control and the shift control.

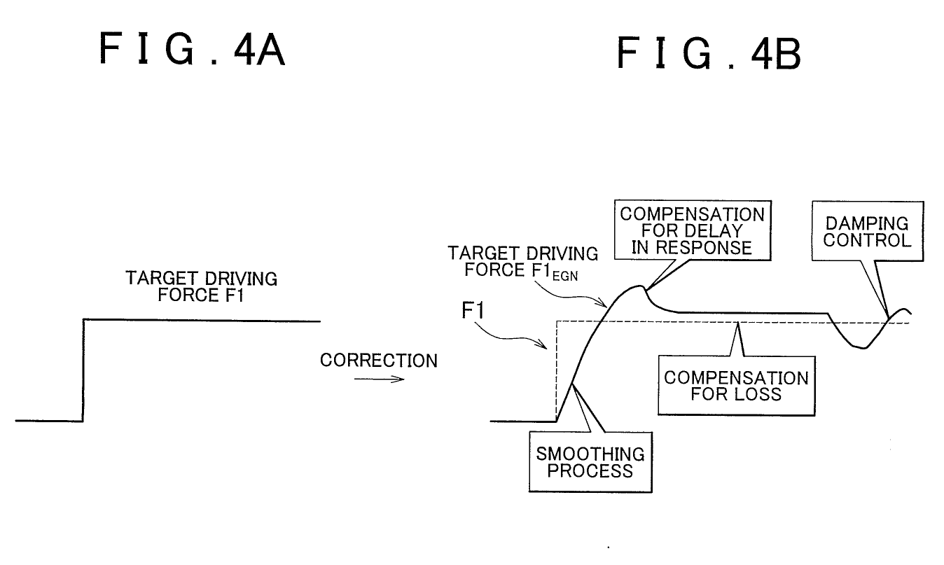

FIGS. 4A and 4B illustrate the manner in which the target driving force is corrected. FIG. 4A illustrates an example of the manner in which the target driving force F1 changes. FIG. 4B illustrates an example of the target driving force F1_{EGN} (indicated by the solid line) used for engine control, which is derived by correcting the target driving force F1 (indicated by the dashed line).

In the engine control, as shown in FIG. 4B, various correction processes specific to the engine control need to be performed on the target driving force, e.g. the process for compensating for the loss of the driving force caused in the driving force transmission system, the smoothing process for preventing the influence of a rapid change in the driving force on drivability (controllability), the process for compensating for a delay in output of the driving force, and the damping control for the driving force transmission system (damping control for reducing jerk, pitch and tip-in).

Reflecting such correction processes on the shift control may cause negative effects on the shift control, because the engine torque differs from the shift speed in response, etc. For example, as shown in FIG. 4B, if the correction for transiently smoothing or fluctuating the target driving force is reflected on the shift control, problems such as a delay in shifting and shift hunting (periodic fluctuation in the speed ratio) occur.

In contrast, according to the embodiment described above, the target driving force F1_{EGN} used for engine control and the target driving force F1_{TM} used for shift control are individually derived from the same target driving force F1. The various correction processes are performed only on the target driving force F1_{ENG} for the engine control, and, therefore, influence of such correction on the target driving force F1_{TM} for the shift control can be avoided.

As shown in FIG. 2, the target driving force F1_{EGN} and the target driving force F1_{TM} thus derived are coordinated with a driving force indicated by an instruction from the DSS, if necessary.

The DSS provides an appropriate instruction as an alternative to the input of the driver or an appropriate instruction to make a correction to the input of the driver, based on the information concerning obstacles located around the vehicle, which is captured, for example, by a camera or a radar, the road information and ambient area information obtained from a navigation system, the current position information obtained from a GPS positioning device of the navigation system, or various information obtained via communication with the operation center, vehicle-to-vehicle communication or road-to-vehicle communication. Examples of the instructions include an instruction from the DSS during the automatic cruise control or the automatic or semi-automatic running control similar to the automatic cruise control, and an instruction from the DSS while the intervention-deceleration control or steering assist control is performed, for example, to avoid an obstacle.

The signals indicating the target driving force F1_{EGN} and the target driving force F1_{TM} that have undergone a necessary coordination process are output to a power train manager (hereinafter, referred to as a “PTM”: Power-Train Manager). The PTM is a manager that functions as an instruction coordination portion of the drive control system.

At the highest level of the PTM, the signals indicating the target driving force F1_{EGN} and the target driving force F1_{TM} (N) from the P-DRM are transmitted to a manager of the dynamic behavior control system (hereinafter, referred to as a “VDM”: Vehicle Dynamics Manager). The VDM is arranged at the level subordinate to a manager that functions as a driver's intention detecting portion of the brake control system (hereinafter referred to as a “B-DRM”: Brake Driver Model). The VDM is a manager that functions as a vehicle movement coordination portion. Examples of such system that stabilizes the dynamic behavior of the vehicle include a traction control system (a system that suppresses unnecessary wheelspin of the drive wheels that is likely to occur when the vehicle starts or accelerates on a slippery road), a system that suppresses a side skid that is likely to occur when the vehicle enters a slippery road, a system that stabilizes the orientation of the vehicle to prevent the vehicle from spinning or sliding off the track if the stability reaches its limit when the vehicle is going round a curve, and a system that actively makes a difference in the driving force between the right and left rear wheels of the four-wheel drive vehicle, thereby causing a yaw moment.

At the level subordinate to the VDM, a steering control unit that controls the actuators for the front steering device 500 and the rear steering device 520, and a suspension control unit that controls the actuators for the suspensions 620 are arranged in parallel with the brake control unit that controls the actuators for the brakes 560. In the B-DRM, a target braking force calculation portion converts the electric signal transmitted from a brake sensor into a signal indicating a target braking force. This signal is then transmitted via the VDM to the brake control unit. While not described in detail in this specification, the target braking force calculated by the target braking force calculation portion undergoes various correction (coordination) processes in the same or similar manner in which the target driving force F1_{EGN} and the target driving force F1_{TM} undergo correction (coordination) processes, as described later in detail. Then, the signal indicating the target braking force derived after correction (coordination) is output to the brake control unit.

The target driving force F1 is primarily determined based mainly on the input of the driver. A driving force correction portion of the VDM secondarily provides an instruction to correct the target driving force F1 to stabilize the dynamic behavior of the vehicle. Namely, the driving force correction portion of the VDM provides instructions to correct the target driving force F1_{EGN} and the target driving force F1_{TM}, if necessary. In this case, preferably, the driving force correction portion of the VDM provides instructions indicating the absolute amounts of the target driving force that should replace the target driving force F1_{EGN} and the target driving force F1_{TM}, not the correction amounts ΔF by which the target driving force F1_{EGN} and the target driving force F1_{TM} should be increased or decreased. Hereafter, the absolute amounts of the target driving force indicated by the instructions from the VDM, which are derived from the target driving force F1_{ENG} and the target driving force F1_{TM}, will be referred to as a “target driving force F2_{EGN}” and a “target driving force F2_{TM}”, respectively.

As shown in FIG. 2, the signals that indicate the target driving force F2_{EGN} and the target driving force F2_{TM} are input in the PTM. At this time, the signals that indicate the target driving force F2_{EGN} and the target driving force F2_{TM} are input in the engine control system transmission route and the T/M control system transmission route, respectively. Then, the target driving force F2_{EGN} and the target driving force F2_{TM} are coordinated with the target driving force F1_{EGN} and the target driving force F1_{TM} at the input portions of the transmission routes, respectively. In this coordination process, preferably, a higher priority is given to the target driving force F2_{ENG} and the target driving force F2_{TM} than to the target driving force F1_{EGN} and the target driving force F1_{TM}, respectively, to give a higher priority to stable dynamic behavior of the vehicle. The target driving force that is derived through such coordination process will be referred to as a “target driving force F3_{EGN}”, and a “target driving force F3_{TM}”.

In the T/M control system transmission route, the target driving force F3_{TM} is converted into the throttle valve opening amount Pa (%), and the signal that indicates the throttle valve opening amount Pa (%) is transmitted to a target shift speed setting portion, as shown in FIG. 2. The target shift speed setting portion sets the final target shift speed based on the predetermined shift diagram (shift diagram indicating the relationship between the throttle valve opening amount and the wheel speed). The final target shift speed may be directly set based on the predetermined shift diagram (shift diagram indicating the relationship between the driving force and the wheel speed) without converting the target driving force F3_{TM} into the throttle valve opening amount Pa (%).

The signal indicating the target shift speed thus set in the PTM is output to the T/M control unit arranged at the level subordinate to the PTM. The T/M control unit controls the actuator for the transmission 240 to achieve the target shift speed Nth.

In the engine control system transmission route, an “F→Te conversion portion” converts the mode of expressing the target driving force F3_{EGN} from the mode where it is expressed by the driving force (N) to the mode where it is expressed by the engine torque (Nm), as shown in FIG. 2. An engine torque coordination portion coordinates the target engine torque T3_{EGN} (Nm) with the instructed engine torque (Nm) indicated by the signal transmitted from the T/M control unit to the PTM. Thus, a final target engine torque T4_{EGN} (Nm) is set. The manner in which the target engine torque T3_{EGN} is coordinated with the instructed engine torque (Nm) is not particularly limited. For example, a higher priority may be given to the instructed engine torque (Nm) indicated by the signal from the T/M control unit.

The signal indicating the final target engine torque T4_{EGN} that have undergone a coordination process at the engine torque coordination portion is output to the engine control unit arranged at the level subordinate to the PTM. The engine control unit and the T/M control unit control the actuator for the engine 140 to achieve the target engine torque indicated by the signal from the PTM.

According to the embodiment described so far, the target driving force F1_{EGN} and the target driving force F1_{TM} calculated by the target driving force calculation portion of the P-DRM undergo various correction (coordination) processes, and the signals that indicate the target driving force that have undergone various correction (coordination) processes are output to the engine control unit and the T/M control unit, respectively. These control units control the actuators for the engine 140 and the transmission 240, whereby the target driving force F1_{EGN} and the target driving force F1_{TM} (if the target driving force F1_{EGN} and the target driving force F1_{TM} have undergone coordination processes, the target driving force F2 and the target driving force F3) are achieved.

The embodiment of the invention that has been described in the specification is to be considered in all respects as illustrative and not restrictive. The technical scope of the invention is defined by claims, and all changes which come within the meaning and range of equivalency of the claims are therefore intended to be embraced therein.

For example, in the embodiment described above, FIGS. 4A and 4B illustrate the correction process specific to the engine control, which is performed to derive the target driving force F1_{EGN} from the target driving force F1. However, the target driving force F1_{TM} may be output to the T/M control system transmission route without undergoing any correction (namely, the target driving force F1_{TM} is equal to the target driving force F1). Alternatively, the target driving force F1_{TM} may be output after undergoing correction specific to the shift control.

In the embodiment, the engine 140 includes an electronic throttle valve, and is used as the power source. However, the invention may be applied to a configuration where the motor without an electronic throttle valve is used as the power source.

1. A vehicle integrated-control apparatus that is mounted in a vehicle provided with a power train including a drive source and a transmission, and that controls the drive source and the transmission in an integrated manner, comprising:
a first target value deriving device that primarily derives a control target value based on an instruction provided by a driver or an automatic operating device;
a second target value deriving device that intermediately derives, based on the control target value, two control target values that are expressed in a same unit of physical quantity as that of the control target value, and that differ from each other;
a third target value deriving device that finally derives control targets that are expressed by units of physical quantities or modes appropriate for control of the drive source and control of the transmission based on the intermediately derived control target values, respectively; and
a controller that controls the drive source and the transmission to achieve the finally derived control targets, wherein
the control targets are an engine torque and a target shift speed.

2. The vehicle integrated-control apparatus according to claim 1, further comprising:
a first signal transmission system that transmits a signal indicating the control target primarily derived based on the instruction provided by the driver or the automatic operating device to a drive source control unit that controls the drive source; and
a second signal transmission system that transmits the signal to a transmission control unit that controls the transmission.

3. The vehicle integrated-control apparatus according to claim 2, wherein
the control target values are intermediately derived by correcting the signal transmitted through the first signal transmission system such that the signal transmitted through the first signal transmission system has a waveform different from a waveform of the signal transmitted through the second signal transmission system.

4. A vehicle integrated-control method that is applied to a vehicle provided with a power train including a drive source and a transmission, and that is performed to control the drive source and the transmission in an integrated manner, comprising:
primarily deriving a control target value based on an instruction provided by a driver or an automatic operating device;
intermediately deriving, based on the control target value, two control target values that are expressed in a same unit of physical quantity as that of the control target value, and that differ from each other;
finally deriving control targets that are expressed by units of physical quantities or modes appropriate for control of the drive source and control of the transmission based on the intermediately derived control target values, respectively; and
controlling the drive source and the transmission to achieve the finally derived control targets, wherein
the control targets are an engine torque and a target shift speed.

5. The vehicle integrated-control method according to claim 4, further comprising:
transmitting a signal indicating the control target primarily derived based on the instruction provided by the driver or the automatic operating device to a drive source control unit that controls the drive source; and
transmitting the signal to a transmission control unit that controls the transmission.

6. The vehicle integrated-control method according to claim 5, wherein
the control target values are intermediately derived by correcting the signal transmitted to the drive source control unit such that the signal transmitted to the drive source control unit has a waveform different from a waveform of the signal transmitted to the transmission control unit.
